(19) United States
(12) Patent Application Publication
(10) Pub. No.: US 2023/0344739 A1
(43) Pub. Date: Oct. 26, 2023

(54) METHODS AND APPARATUS TO GENERATE AN EGRESS TIMESTAMP

(71) Applicants: Surekha Peri, Austin, TX (US); Mark Aldo Bordogna, Andover, MA (US); Job Abraham, Fulshear, TX (US); Sankaradithyan Gunasekharan, Austin, TX (US)

(72) Inventors: Surekha Peri, Austin, TX (US); Mark Aldo Bordogna, Andover, MA (US); Job Abraham, Fulshear, TX (US); Sankaradithyan Gunasekharan, Austin, TX (US)

(21) Appl. No.: 18/344,801

(22) Filed: Jun. 29, 2023

(51) Int. Cl. H04L 43/106; H04L 43/0823; H04L 43/067

(52) U.S. Cl. CPC H04L 43/106; H04L 43/0847; H04L 43/067

(57) ABSTRACT

Methods, apparatus, systems, and articles of manufacture to generate a timestamp are disclosed. Examples disclosed herein generate a correction factor based on a first timestamp and a second timestamp, the first timestamp generated before a first data packet is obtained by ethernet physical coding sublayer (PCS), the second timestamp generated before the first data packet is obtained by a physical ethernet port coupled to the ethernet PCS; and generate a third timestamp for a second data packet based on the correction factor and a fourth timestamp, the fourth timestamp generated by network interface circuitry for the second data packet.

### BACKGROUND

A distributed network and/or a cluster network is a network of computing devices (also referred to as nodes, servers, etc.) that work together to execute one or more tasks. The computing devices in such a network may perform different sub portions of the one or more tasks (e.g., to increase speed and/or performance) and/or may perform the same portion(s) of the one or more tasks (e.g., for high availability to mitigate problems when one or more nodes fail). Distributed networks may rely on time synchronization to manage, secure, plan, and/or debug issues associated with the execution of the one or more tasks. Time synchronization includes synchronizing the clocks of the computing devices in the network. Some synchronizing techniques include transmitting an egress timestamp from one node to another.

### BRIEF DESCRIPTION OF THE DRAWINGS

FIG. 1 is a block diagram of an example distributed network described in conjunction with examples disclosed herein to generate an egress timestamp.

FIG. 2 is a block diagram of an example implementation of the network circuitry of FIG. 1.

FIG. 3 is a block diagram of another example implementation of the network circuitry of FIG. 1.

FIG. 4 illustrates a flowchart representative of example machine readable instructions and/or operations that may be executed, instantiated, and/or performed by programmable circuitry to implement the example network circuitry of FIG. 2.

FIG. 5 illustrates a flowchart representative of example machine readable instructions and/or operations that may be executed, instantiated, and/or performed by programmable circuitry to implement the example network circuitry of FIG. 3.

FIG. 6 illustrates a flowchart representative of example machine readable instructions and/or operations that may be executed, instantiated, and/or performed by programmable circuitry to implement the example network circuitry of FIGS. 2 and/or 3.

FIG. 7 is a block diagram of an example processor platform including programmable circuitry structured to execute, instantiate, and/or perform the computer readable instructions and/or perform the example operations of FIGS. 4, 5, and/or 6 to implement the example network circuitry of FIG. 2 and/or 3.

FIG. 8 is a block diagram of an example implementation of the programmable circuitry of FIG. 7.

FIG. 9 is a block diagram of another example implementation of the programmable circuitry of FIG. 7.

FIG. 10 is a block diagram of an example software/firmware/instructions distribution platform (e.g., one or more servers) to distribute software, instructions, and/or firmware (e.g., corresponding to the example machine readable instructions of FIG. 7 to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. In general, the same reference numbers will be used throughout the drawing(s) and accompanying written description to refer to the same or like parts. The figures are not necessarily to scale.

### DETAILED DESCRIPTION

Descriptors “first,” “second,” “third,” etc. are used herein when identifying multiple elements or components which may be referred to separately. Unless otherwise specified or understood based on their context of use, such descriptors are not intended to impute any meaning of priority or ordering in time but merely as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

In distributed processing systems (e.g., time-sensitive distributed processing systems), time synchronization ensures that all the nodes (e.g., servers, computing devices, mobile devices, etc.) in a distributed cluster have the same view of the time. To achieve accurate time synchronization, accurate timestamp exchange between the nodes is needed. Time synchronization protocols include a first node transmitting a first message (e.g., M) to a second node and, after the first message is transmitted, sending a second message (e.g., F) with an egress timestamp of the first message M. The second node can use the first message, the second message, and/or the egress timestamp to synchronize its internal clock with the internal clock of the first node. The egress timestamp is a timestamp corresponding to how long it took for the first node to transmit the first message M after the instructions to send the first message M was output by the host application (e.g., implemented on the first node) to the networking circuitry of the first node. However, a host application of the first node may not be aware of the time it takes the network circuitry to transmit a data packet after the host application outputs the data packet. Accordingly, hardware and/or software is needed to generate an egress timestamp corresponding to the time it takes for the data packet to be transmitted after being output by the host application to the network circuitry (e.g., the amount of time needed to prepare and transmit the data packet after output by the host application). To achieve accurate time synchronization and network quality of service (QoS) measurements, an accurate egress timestamp is needed. High accuracy egress timestamps are also used for other applications such as network time protocol (NTP) servers, two-way active measurement protocols (TWAMP), and other delay measurement protocols that help measure the network QoS.

In radio access networks with stringent requirements on Time Transmit Intervals (TTI), the higher the synchronization accuracy, the higher the performance of one or more services. Timestamps are also utilized in network delay measurements to establish network QoS and drive the preferential workload placement in the distributed networks. As the sizes of distributed networks increase, the size of the supported clock topologies increases. The increase in the size of the supported clock topology results benefits from more accurate timestamps.

Some techniques for generating egress timestamps support a complex software model, a low-speed timestamping protocol, or a low accuracy timestamping protocol. Examples disclosed herein facilitate a technique to achieve a high precision high rate using a two-operation timestamp protocol with a semi-autonomous, non-packet stateful, virtualization and multi-tenant friendly software model. In examples disclosed herein, an initial, semi-accurate timestamp is generated near the last controllable point of an egress pipeline. A packet with this initial timestamp, also referred to herein as a semi-accurate timestamp, is looped back to the network driver. Because the packet is looped back there is no need for packet buffering. Packet buffering is complex due to the need to correlate potential out of order timestamps in the buffer and due to the sensitivity to link failures, link flapping, and/or timestamp retrieval.

After the semi-accurate timestamp for the packet is looped back to the network driver, the network driver adjusts the semi-accurate timestamp based on a correction factor to generate a corrected timestamp, also referred herein as an accurate timestamp. The correction factor corresponds to the amount of time it takes from when a semi-accurate timestamp is generated to when the packet is sent to the final hardware component (e.g., the ethernet port) before being transmitted to the second node. The correction factor is generated based on comparisons of previously generated semi-accurate timestamps with previously generated accurate timestamps. In this manner, the network driver can increase the accuracy of the semi-accurate timestamp with a correction factor and send the accurate timestamp to the host application in less time and/or with less complexity than it takes for the accurate timestamp to be transmitted back to the host application.

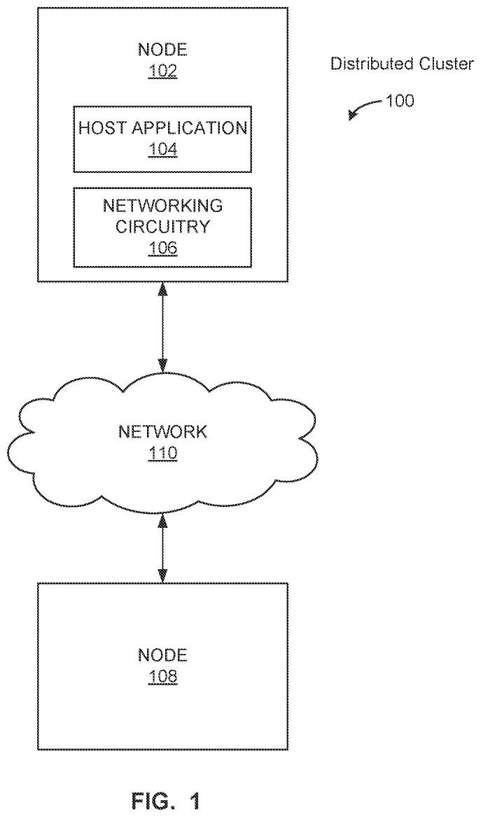

FIG. 1 is a block diagram of an example distributed cluster environment 100 to generate a fast and accurate egress timestamp. The example environment 100 includes a first example node 102, an example host application 104, example networking circuitry 106, a second example node 108, and an example network 110. Although the example environment 100 of FIG. 1 includes two nodes, there may be any number of nodes in the environment 100. Additionally, although the example node 102 includes the host application 104 and the networking circuitry 106, the host application 104 and the networking circuitry 106 can be implemented in node 108.

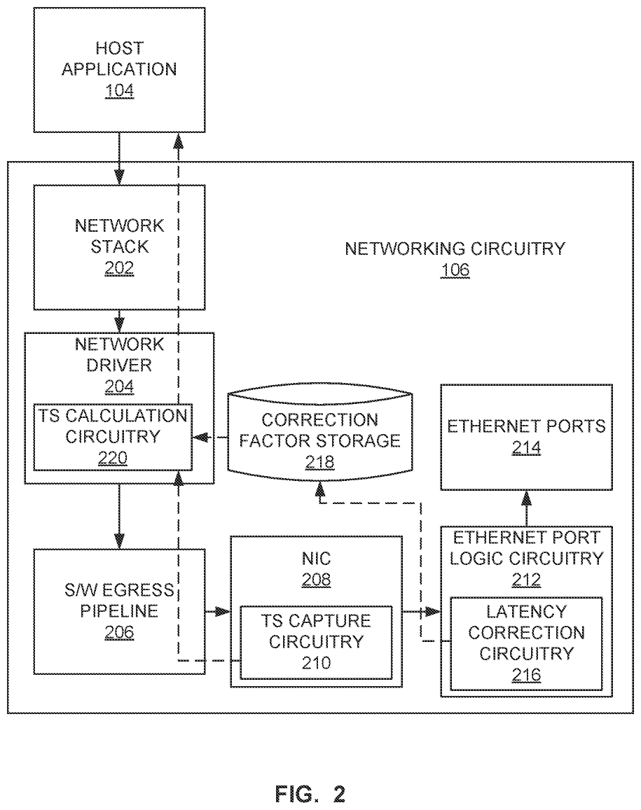

The example nodes 102, 108 of FIG. 1 may be computing devices, servers, mobile devices, and/or any other devices that are capable of time synchronization with other devices. In some examples, the nodes 102, 108 are different types of devices (e.g., the node 102 is a server and the node 108 is a mobile device). The example node 102 includes the example host application 104 and the example networking circuitry 106. The host application 104 determines when a data packet needs to be sent for time synchronization purposes and/or any other purposes. For example, to synchronize clocks with the node 108, the host application 104 instructs the network circuitry 106 to transmit a data packet to the example node 108. After instructing the network circuitry 106 to transmit the data packet, the host application 104 obtains an egress timestamp for the packet from the networking circuitry 106 and instructs the networking circuitry 106 to transmit a second data packet to the node 108, the second data packet including the egress timestamp. In this manner, the node 108 can synchronize its clock based on the first data packet, the second data packet, and/or the egress timestamp. The example host application 104 is further described below in conjunction with FIGS. 2 and/or 3.

The example networking circuitry 106 of FIG. 1 obtains instructions to send out data packets and transmits the data packets to receiving devices via the network 110 based on the instructions. Additionally, the networking circuitry 106 generates semi-accurate timestamps, correction factors, and/or egress timestamps (e.g., based on the semi-accurate timestamps and the correction factors). The semi-accurate timestamps are timestamps generated when the data packet has reached a particular location in the network circuitry 106 (e.g., the last controllable point of a NIC). The correction factor is generated based on a difference between when a semi-accurate timestamp was generated and the time the data packet corresponding to the semi-accurate timestamp was sent to the last hardware component(s) of the network circuitry 106 (e.g., the ethernet port). The egress timestamp is generated by adding a correction factor (e.g., corresponding to historical timestamp data) to a semi-accurate timestamp for a data packet. The example networking circuitry 106 is further described below in conjunction with FIGS. 2 and/or 3.

The example network 110 of FIG. 1 is a system of interconnected systems exchanging data. The example network 110 may be implemented using any type of public or private network such as, but not limited to, the Internet, a telephone network, a local area network (LAN), a cable network, and/or a wireless network. To enable communication via the network 110, the example 102, 108 includes a communication interface that enables a connection to an Ethernet, a digital subscriber line (DSL), a telephone line, a coaxial cable, an optical fiber connection, or any wireless connection, etc. In some examples, the nodes 102, 108 are connected via the example network 110.

FIG. 2 illustrates a block diagram of the host application 104 and the networking circuitry 106 of FIG. 1. The example networking circuitry 106 of FIG. 2 includes an example network stack 202, an example network driver 204, an example software (S/W) egress pipeline 206, an example network interface controller (NIC) 208, example timestamp (TS) capture circuitry 210, example ethernet port logic circuitry 212, example ethernet ports 214, example latency correction circuitry 216, example correction factor storage 218, and example TS calculation circuitry 220. While the components of the networking circuitry 106 are described as stacks, drivers, controllers, ports, circuitry and/or software, any one of the example network stack 202, the example network driver 204, the example software (S/W) egress pipeline 206, the example network interface controller (NIC) 208, the example timestamp TS) capture circuitry 210, the example ethernet port logic circuitry 212, the example ethernet ports 214, the example latency correction circuitry 216, example correction factor storage 218, the example TS calculation circuitry 220, and/or more generally the networking circuitry 106 can be implemented by a system on chip (SOC), an ASIC, and/or a discrete chip.

The network stack 202 of FIG. 2 obtains instructions from the host application 104 to send a data packet to an external device (e.g., the node 108 of FIG. 1) for time synchronization purposes, QoS measurement purposes, etc. The network stack 202 sets the communication standards that the network hardware is to follow to facilitate communication of the data packet with the node 108 via the network 110. In some examples, the network stack 202 splits the communication into a number of layers (e.g., a physical layer, a data link layer, a network layer, a transport layer, a session layer, a presentation layer, an application layer, etc.) that have specific roles in how the data packet is transferred. The network stack 202 forwards the data packet to the network driver 204.

The network driver 204 of FIG. 2 obtains the data packet from the network stack 202. The network driver 204 controls an interface between the host application 104 and the network 110 (e.g., acting as a bridge between device software and hardware). The network driver 204 marks the metadata of data packets where an egress timestamp is desired so that the TS capture circuitry 210 knows to generate and/or trigger a timestamp after the data packet reaches the NIC 208. Additionally, the network driver 204 generates a timestamp profile identifier based on the characteristics of the data packet. For example, a data packet corresponding to media access control security (MACsec) may result in a different data path than a data packet not corresponding to MACsec, thereby resulting in different egress times. In another example, the traffic class of the data packet may result in different data paths corresponding to different egress times. The network driver 204 can include the timestamp profile identifier in the header of the data packet, in the metadata, etc. The network driver 204 forwards the data packet to the S/W egress pipeline 206 or directly to the NIC 208. The S/W egress pipeline 206 performs additional bump-in-the-wire stack processing and generates NIC descriptors over virtual ethernet interfaces without the need for physical ethernet interface resolution and index management. The data packet travels from the S/W egress pipeline 206 to the NIC 208. The interface and/or connection between the S/W egress pipeline 206 and the NIC 208 is a GMII interface and/or an XMII interface. Additionally, the network driver 204 includes the example TS calculation circuitry 220 to determine an egress timestamp for a data packet based on a semi-accurate timestamp of the data packet and a correction factor, as further described below.

The NIC 208 of FIG. 2 obtains the data packet from the S/W egress pipeline 206. In some examples, the NIC 208 may be a smartNlC, an infrastructure processing unit (IPU), a data processing unit (DPU), a network adapter card (NAC), and/or any other type of hardware egress pipeline circuitry. The NIC 208 provides the node 102 with a dedicated connection to the network 110 of FIG. 1 by implementing physical layer circuitry for communicating with a data link layer standard (e.g., Ethernet, Wi-Fi, etc.). The NIC 208 forwards the packet to the ethernet port logic circuitry 212. The NIC 208 includes the example TS capture circuitry 210, as further described below.

The TS capture circuitry 210 of FIG. 2 determines which data packets are to be timestamped and/or looped back to the host application 104 by processing the metadata of the data packets. As described above, the network driver 204 marks the metadata of data packets where an egress timestamp is desired. Accordingly, the network driver 204 processes the metadata of the data packet to determine if the data packet should be looped back to the network driver 204 after the timestamp is generated. The TS capture circuitry 210 generates, captures, and/or triggers a timestamp when the data packet reaches and/or exits a first threshold point. For example, the TS capture circuitry 210 can generate a TS during, before, or after the data packet leaves the NIC 208. The generated timestamp is a semi-accurate and/or coarse timestamp because it is related to the total egress of the timestamp. However, the data packet still needs to travel through the egress port logic circuitry 212 and the ethernet ports 214 (e.g., corresponding to a more time that should be added to the total egress time). The TS capture circuitry 210 transmits the timestamp to the ethernet port logic circuitry 212 (e.g., directly or via a components of the NIC 208). In some examples, the timestamp is included with and/or embedded in (e.g., included in metadata) the data packet that is forwarded to the ethernet port logic circuitry 212. If the TS capture circuitry 210 determines that the data packet is marked for an egress timestamp, the TS capture circuitry 210 transmits a copy of the data packet with the semi- accurate timestamp back to the network driver 204 (e.g., via the NIC 208 and/or S/W egress pipeline 206). In some examples, instead of transmitting the full copy of the data packet with the timestamp back to the network driver 204, the TS capture circuitry 210 may send back a partial data packet (e.g., an identifier of the data packet, a header of the data packet, etc.) to save resources.

The example ethernet port logic circuitry 212 of FIG. 2 obtains the data packet and determines how to transmit the data packet via one of the ethernet ports 214 based on the data packet (e.g., information in the header and/or metadata). The ethernet port logic circuitry 212 may be a physical coding sublayer (PCS) and/or an Ethernet PCS, which is a defined layer in an Ethernet protocol stack. The ethernet port logic circuitry 212 transmits the data packet to the appropriate ethernet port of the ethernet ports 214 to transmit to a node via the network 110 of FIG. 1. The ethernet port logic circuitry 212 further includes the latency correction circuitry 216. The latency correction circuitry 216 generates a timestamp when the data packet reaches and/or exits a second threshold point. For example, the latency correction circuitry 216 can generate a TS during, before, or after the data packet leaves the ethernet port logic circuitry 212 and/or the ethernet ports 214. The generated timestamp is an accurate timestamp as it closely reflects the time at which the data packet is output by the ethernet port 214. After the second accurate timestamp is generated, the latency correction circuitry 216 generates a correction factor for the data packet based on the first (e.g., semi accurate) and second (accurate) timestamps. For example, the latency correction circuitry 216 may determine a difference between the second timestamp and the first timestamp to generate the correction factor.

The ethernet ports 214 of FIG. 2 transmit the data packet to other devices via the network 110 of FIG. 1. The ethernet ports 214 may be physical ethernet ports, ethernet physical media attachments (PMA), and/or physical media dependents (PMD). The NIC 208, the ethernet port logic circuitry 212, and the ethernet ports 214 may be referred to as the ethernet physical layer (PHY).

In some examples, the latency correction circuitry 216 may determine and/or link a data packet type to the correction factor. For example, the latency correction circuitry 216 may determine the timestamp profile identifier generated by the network driver 204 and link the timestamp profile identifier to the correction factor. Different data packet types (e.g., different profile identifiers) may result in different egress timestamp latencies due to the different paths that the different data packets will take. For example, a data packet corresponding to MACsec may result in a different data path than a data packet not corresponding to MACsec, thereby resulting in different egress times. In another example, the traffic class of the data packet may result in different data paths corresponding to different egress times. The latency correction factor 216 may link correction factors to any characteristic of data packets that may result in different data paths.

In some examples, the latency correction circuitry 216 generates a correction factor based on an average of two or more correction factors. For example, the latency correction circuitry 216 may generate a correction factor by averaging the current correction factor to one or more previously generated correction factors. In some examples, the latency correction circuitry 216 generates the average correction factor per characteristic of the data packet as described above. In some examples, the latency correction circuitry 216 generate an average correction factor based on packets that require egress timestamping. In some examples, the latency correction circuitry 216 randomly selects data packets for averaging (e.g., every Nth packet, every Nth seconds, and/or randomly). The latency correction circuitry 216 stores the generate correction factor, average correction factor, and/or updated average correction factor in the correction factor storage 218. The correction factor storage 218 can be a database, a register, and/or any other type of memory and/or storage.

In some examples, the latency correction circuitry 216 generates, maintains, and/or stores (e.g., in the correction factor storage 218) second order moments (e.g., variance) based on the timestamping information, that the network driver 204 may use to generate an egress timestamp. In some examples, the latency correction circuitry 216 may include filtering logic that applies a weight for samples that are beyond an error tolerance from a current average. The weighted moving average can include both the contribution to the average as well as the aging of the sample. In this manner, momentary network impairments can be prevented from impacting the samples (e.g., link flaps and/or link backpressures that can result in a momentary larger latency and software that can be mitigated by the average). In some examples, instead of hardware latency correction filtering, the latency correction circuitry 216 could be implemented by software-based filtering by randomizing N packets per second on one or more available links. For example, the latency correction circuitry 216 could be implemented by a device time maintenance daemon, decoupled from the timing applications, clock topologies, and/or forward databases. The device time maintenance daemon can be implemented at a low rate and can be implement on a link host in virtualization implementations. In some examples, latency correction circuitry 216 may drop the packets in the hardware/network can be piggy backed with general link maintenance message (e.g., link operations, administration, and maintenance (OAM), other link local messages, etc.). In some examples, the latency correction circuitry 216 applies low pass filtering algorithms with timestamp values as inputs to reduce random errors where constant errors could be predicted via simulations and used to compensate the timestamps. In some examples, the latency correction circuitry 216 can avoid certain types of delays/delay variation (e.g., forward error correction (FEC) transcoding errors, multi-lane demultiplexing/multiplexing delays) which may not be needed to be removed from the timestamp to increase the accuracy of the correction factor. Although the latency correction circuitry 216 provides hardware-based filtering, the latency correction circuitry 216 may be implemented in software to provide a software-based filtering that also utilizes raw data from the hardware.

As described above, the network driver 204 includes the TS calculation circuitry 220 of FIG. 2. The TS calculation circuitry 220 generates an accurate egress timestamp by applying a correction factor to a looped- backed timestamp of a data packet to increase the accuracy of the semi-accurate timestamp. When the TS calculation circuitry 220 obtains a data packet that has been looped back (e.g., a data packet copy) from the TS capture circuitry 210 via the S/W egress pipeline 206, the TS calculation circuitry 220 determines the type of data packet (e.g., based on the timestamp profile identifier associated with the looped-back data packet). After the type of data packet is determined, the TS calculation circuitry 220 accesses a correction factor from the correction factor storage 218 that corresponds to the type of data packet. After the correction factor is obtained, the TS calculation circuitry 220 applies the correction factor to the semi-accurate timestamp associated with the looped-back timestamp. For example, the TS calculation circuitry 220 generates the egress timestamp by adding the correction factor to the semi-accurate timestamp. After the egress timestamp is generated, the TS calculation circuitry 220 (e.g., directly or using another component of the network driver 204) transmits (e.g., via the network stack 202) the egress timestamp to the host application 104 (e.g., with and/or as part of the looped-back timestamp and/or information corresponding to the looped-back timestamp). In this manner, the host application 104 can generate a follow-up message including the egress timestamp to send to the node 108 for time synchronization, QoS measurement, etc. Although the TS calculation circuitry 220 can pull the correction factor periodically, the correction factor can be pushed to the TS calculation circuitry 220 via interrupts or as in-band data that is piggybacked with data packets.

Although the latency correction circuitry 216 is implemented in the ethernet port logic circuitry 212 and the TS calculation circuitry 220 is implemented in the network driver 204 in FIG. 2, the ethernet port circuitry 212 and/or the TS calculation circuitry 220 or a portion of the respective circuitries may be implemented in another component of the node 102. For example, the TS calculation circuitry 220 could be implemented in the host application 104 and a portion of the functionality of the latency correction circuitry 216 may be implemented at the network driver 204 and/or the host application 104.

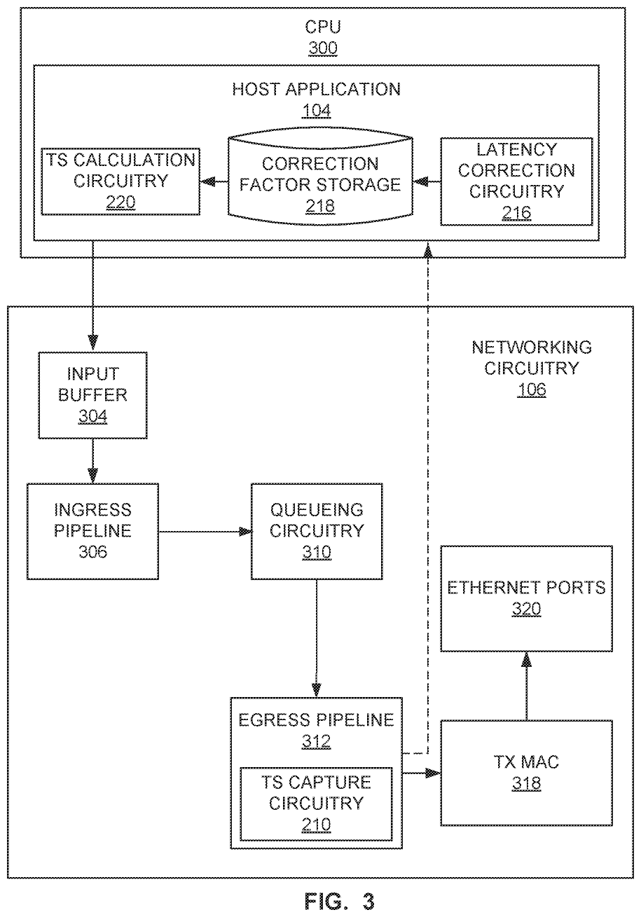

FIG. 3 illustrates an alternative block diagram of the host application 104 and the networking circuitry 106 of FIG. 1. In FIG. 1, the host application 104 of FIG. 1 and the correction factor storage 218 of FIG. 2 is implemented in a central processing unit (CPU) 300. The example networking circuitry 106 of FIG. 3 includes the TS capture circuitry 210 and the latency correction circuitry 216 of FIG. 2. The example networking circuitry 106 of FIG. 3 further includes, an input buffer 304, an ingress pipeline 306, example quieting circuitry 310, an example egress pipeline 312, an example transmitter (TX) MAC 318, and example ethernet ports 320.

The networking circuitry 106 of FIG. 1 can generate seven timestamps (TS1 to TS7) per packet that are captured, generated, and/or triggered at different locations in the hardware pipeline. For example, the fifth timestamp (TS5) can be generated and/or captured when a output data packet enters the egress pipeline 312 (e.g., an egress parser of the egress pipeline), which is the last timestamp available to the programmable pipeline. Additionally, the last timestamp TS7 can be captured when the output data packet exits the TX MAC 318 and enters a physical layer (PHY). The TS7 timestamp can be stored in a buffer (e.g., a 4-deep per-port first input first output buffer) which can be retrieved by the CPU 300 via a control-plane API call after the data packet is transmitted out.

In operation, the host application 104 implemented by the CPU 300 outputs an egress data packet to be timestamped for time synchronization purposes, QoS measurement purposes, etc. to the example egress pipeline 312 (e.g., via the input buffer 304, the ingress pipeline 306, and the queueing circuitry 310). In some examples the host application 104 implements a device maintenance daemon that outputs the data packet. When the data packet reaches the ingress pipeline 306, the ingress pipeline 306 (e.g., a ingress match-action pipeline circuitry of the ingress pipeline 306) identifies the data packet based on a packet classification rule to output the data packet to the egress pipeline 312 via the NIC 208 and queueing circuitry 310. Egress mirroring to CPU port can be enabled by setting intrinsic metadata and passing the data packet to the egress pipeline 312.

The TS capture circuitry 210 generates and/or captures the TS5 timestamp when the data packet enters the egress pipeline 312 (e.g., an egress parser of the egress pipeline 312). The TS capture circuitry 210 makes the TS5 timestamp available as metadata. The egress pipeline 312 (e.g., an egress de-parser of the egress pipeline 312) marks the TS5 timestamp as minor metadata. Additionally, the egress pipeline 312 outputs the original data pack to the TX MAC 318 of the egress port.

In the egress pipeline 312, the egress pipeline 312 (e.g., the egress de-parser of the egress pipeline 312) adds a customer header with the TS5 timestamp. The egress pipeline 312 and/or the TX MAC 318 transmits the TS5 timestamp, the minor metadata, the mirrored data packet and/or the custom header to the host application 104. The latency correction circuitry 216 of the host application 104 receives the mirrored packet. The latency correction circuitry 216 decapsulates the custom header of the mirrored packet to obtain the TS5 timestamp. Additionally, the latency correction circuitry 216 reads the TS7 timestamp via a control plane API and generates an average post timestamping delay (e.g., a correction factor such as, TS7-TS5) which is stored in the example correction factor storage 218. In this manner, the TS calculation circuitry 220 can apply the post timestamping delay to a mirrored timestamp to determine the egress timestamp of the mirrored timestamp as described above in conjunction with FIG. 2.

While an example manner of implementing host application 104 and/or the networking circuitry 106 of FIG. 1 is illustrated in FIGS. 2 and/or 3, one or more of the elements, processes, and/or devices illustrated in FIGS. 2 and/or 3 may be combined, divided, re-arranged, omitted, eliminated, and/or implemented in any other way. Further, the network stack 202, the network drive 204, the S/W egress pipeline 206, the NIC 208, the TS capture circuitry 210, the ethernet port logic circuitry 212, the ethernet ports 214, the latency correction circuitry 216, the correction factor storage 218, the TS calculation circuitry 220, the CPU 300, the input buffer 304, the ingress pipeline 306, the queuing circuitry 310, the egress pipeline 312, the TX MAC 318, the ethernet ports 320, and/or, more generally, host application 104 and/or the networking circuitry 106 of FIGS. 2 and/or 3, may be implemented by hardware alone or by hardware in combination with software and/or firmware. Thus, for example, any of the network stack 202, the network drive 204, the S/W egress pipeline 206, the NIC 208, the TS capture circuitry 210, the ethernet port logic circuitry 212, the ethernet ports 214, the latency correction circuitry 216, the correction factor storage 218, the TS calculation circuitry 220, the CPU 300, the input buffer 304, the ingress pipeline 306, the queuing circuitry 310, the egress pipeline 312, the TX MAC 318, the ethernet ports 320, and/or, more generally, host application 104 and/or the networking circuitry 106 of FIGS. 2 and/or 3, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example host application 104 and/or the networking circuitry 106 of FIGS. 2 and/or 3 may include one or more elements, processes, and/or devices in addition to, or instead of, those illustrated in FIGS. 2 and/or 3, and/or may include more than one of any or all of the illustrated elements, processes, and devices.

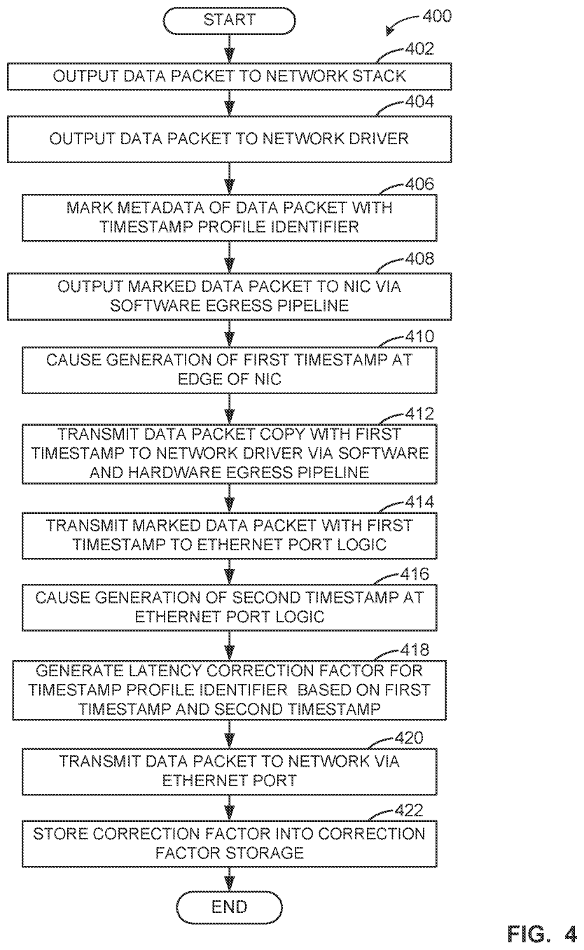

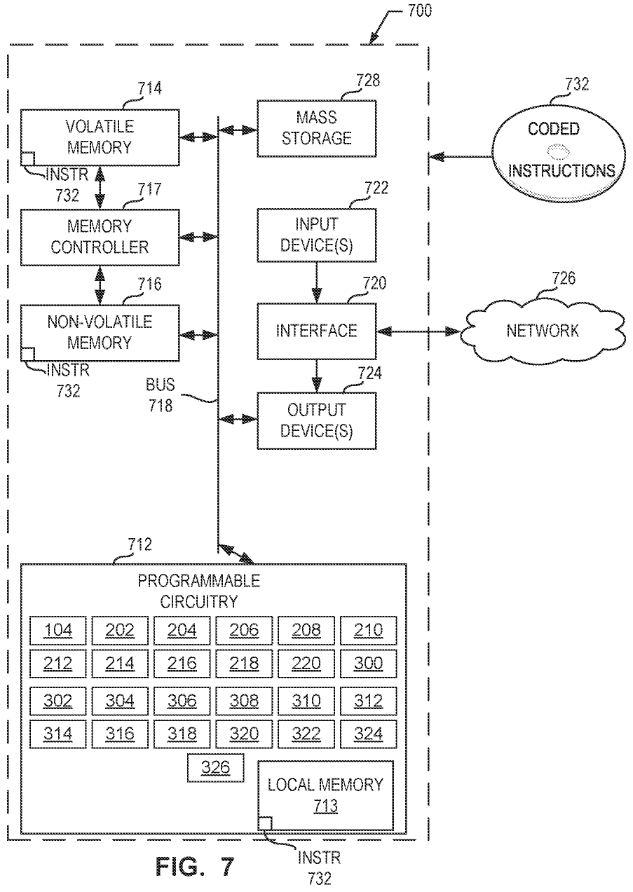

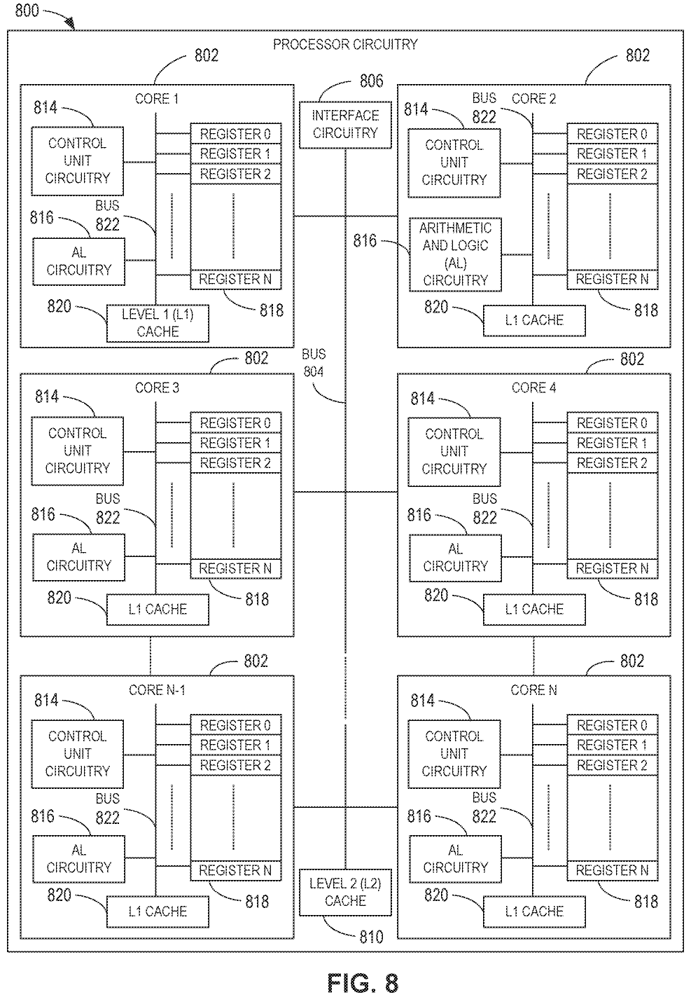

Flowchart(s) representative of example machine readable instructions, which may be executed by programmable circuitry to implement and/or instantiate the host application 104 and/or the networking circuitry 106 of FIGS. 2 and/or 3 and/or representative of example operations which may be performed by programmable circuitry to implement and/or instantiate host application 104 and/or the networking circuitry 106 of FIGS. 2 and/or 3, are shown in FIGS. 4-6. The machine readable instructions may be one or more executable programs or portion(s) of one or more executable programs for execution by programmable circuitry such as the programmable circuitry 712 shown in the example processor platform 700 discussed below in connection with FIG. 7 and/or may be one or more function(s) or portion(s) of functions to be performed by the example programmable circuitry (e.g., an FPGA) discussed below in connection with FIGS. 8 and/or 9. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 4-6, many other methods of implementing the example host application 104 and/or the networking circuitry 106 of FIGS. 2 and/or 3 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 4-6 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/ or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 4 is a flowchart representative of example machine readable instructions and/or example operations 400 that may be executed, instantiated, and/or performed by programmable circuitry(ies) to generate a correction factor that can be used to generate egress timestamps. For example, the example operations 400 may be executed, instantiated, and/or performed by host application 104 and/or the network circuitry 106 of FIGS. 2. The example machine-readable instructions and/or the example operations 400 of FIG. 4 begin at block 402, at which the host application 104 outputs a data packet to the network stack 202. As described above, the host application 104 may mark the data packet as an egress data packet so that the network circuitry 106 knows to generate and return an egress timestamp for the data packet. The network stack 202 may sets the communication standards that the network hardware follows to facilitate communication of the data packet with the node 108 via the network 110 based on the data packet as further described above in conjunction with FIG. 2.

At block 404, the example network stack 202 outputs the data packet to the network driver 204. At block 406, the example network driver 204 marks the metadata of the data packet with a timestamp profile identifier based on the characteristics of the data packet (e.g., with or with MACsec, based on the traffic class, etc.). At block 408, the network driver 204 outputs the marked data packet to the NIC 208 via the S/W egress pipeline 206. At block 410, the example TS capture circuitry 210 causes the generation, triggering, and/or capture of a first timestamp (e.g., a semi-accurate timestamp) at the edge of the NIC 208 (e.g., just before, during, or after the data packet is output to the ethernet port logic circuitry 212). At block 412, the TS capture circuitry 210 generates and transmits a data packet copy with the first timestamp to the network driver 204 via the SW egress pipeline 206. In some examples, the TS capture circuitry 210 outputs a portion of (e.g., the header or metadata) of the data packet and information related to the data packet (e.g., an identifier) with the timestamp to the network driver 204.

At block 414, the example NIC 208 transmits the marked data packet with the first timestamp to the ethernet port logic 212. At block 416, the example latency correction circuitry 216 causes the generation and/or capture of a second timestamp (e.g., an accurate timestamp) at the ethernet port logic. At block 418, the example latency correction circuitry 216 generates a latency correction factor for the timestamp profile identifier of the data packet based on the first timestamp and the second timestamp. For example, the latency correction circuitry 216 may generate a correction factor based on a mathematical difference between the second timestamp and the first timestamp.

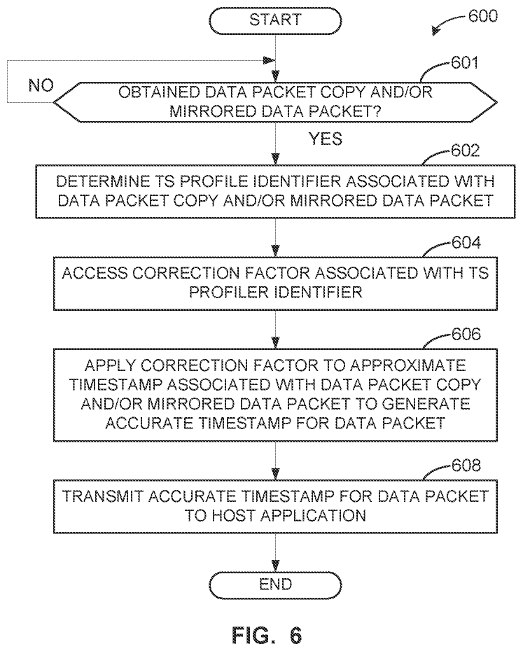

At block 420, the example ethernet port logic circuitry 212 transmits the data packet to the network via the ethernet port 214. In this manner the ethernet port 214 can transmit the data packet to the node 108 via the network 110. At block 422, the example latency correction circuitry 216 stores the correction factor into the correction factor storage 218 (e.g., based on the timestamp profile identifier). In some examples, the latency correction circuitry 216 calculates an average correction factor based on the generated correction factor for the data packet and one or more previous correction factors generated from previous data packet(s) that correspond to the same timestamp profile identifier. In such examples, the latency correction circuitry 216 stores the average correction factor for the timestamp profile identifier in the correction factor storage 218. As further described below in conjunction with FIG. 6, the TS calculation circuitry 220 uses the correction factors to adjust a semi accurate timestamp into an accurate timestamp to generate an egress timestamp and transmits the egress timestamp to the host application 104. In this manner, the host application 104 can quickly generate a second data packet with the egress timestamp for time synchronization purposes and/or QoS measurement.

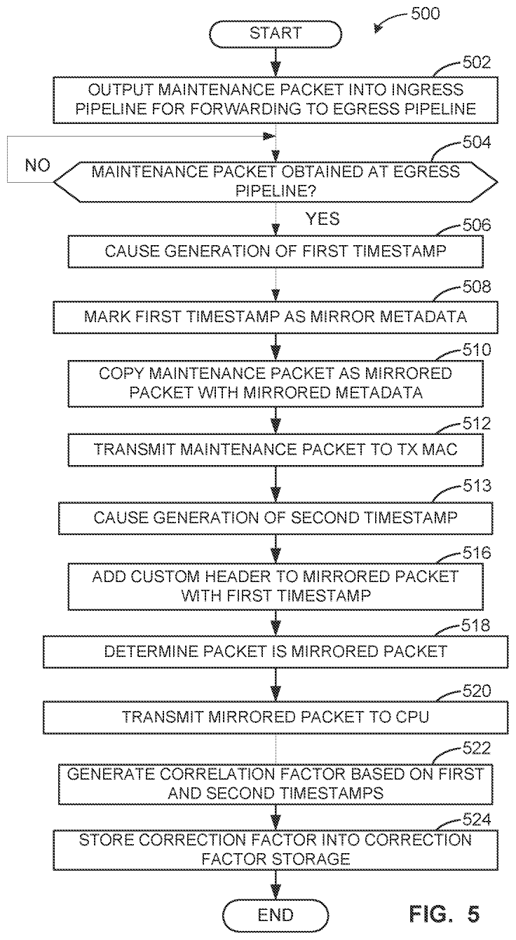

FIG. 5 is a flowchart representative of example machine readable instructions and/or example operations 500 that may be executed, instantiated, and/or performed by programmable circuitry(ies) to generate a correction factor that can be used to generate egress timestamps. For example, the example operations 500 may be executed, instantiated, and/or performed by host application 104 and/or the network circuitry 106 of FIGS. 3. The example machine-readable instructions and/or the example operations 500 of FIG. 5 begin at block 502, at which the host application 104 outputs a maintenance packet to the input buffer 304 for forwarding to the egress pipeline 312. The maintenance packet can be any type of egress packet and/or data packet.

At block 504, the example TS capture circuitry 210 determines if the maintenance packet has reached the egress pipeline 312. If the TS capture circuitry 210 determines that the maintenance packet has not reached the egress pipeline 312 (block 504: NO), control returns to block 504 until the maintenance packet reaches the egress pipeline 312. If the TS capture circuitry 210 determines that the maintenance packet has reached the egress pipeline 312 (block 504: YES), the TS capture circuitry 210 causes generation, triggering, and/or capture of a first timestamp (e.g., TS5 timestamp) (block 506). At block 508, the egress pipeline 312 (e.g., an egress de-parser of the egress pipeline 312) marks the first timestamp as mirror metadata. At block 510, the TS capture circuitry 210 copies the maintenance packet to generate a mirrored packet with the mirrored metadata.

At block 512, the example egress pipeline 312 transmits the maintenance packet to the TX MAC 318 to be sent to the node 108 via the network 110 using the ethernet port 320. At block 513, the TX MAC 318 causes generation and/or capture of a second (e.g., accurate) timestamp (TS7 timestamp) just before, during, and/or after the maintenance packet has left the TX MAC 318 to be transmitted to the ethernet ports 320 for transmission via the network 110. The TX MAC 318 may store the second TS7 timestamp in a buffer. In this manner, the host application 104 can access the timestamp to generate and/or update a correction factor.

At block 516, when the mirrored packet enters the egress pipeline 312, the TS circuitry 210 determines that the mirrored packet is a mirrored packet (e.g., based on the mirrored metadata) and generates a customer header for the mirrored packet with the first timestamp. At block 518, the example TX MAC 318 obtains the mirrored packet with the custom header from the egress pipeline 312 and determines that the packet is a mirrored packet. For example, the TX MAC 318 may determine that the packet is a mirrored packet based on the metadata, header, and/or other data corresponding to the mirrored packet.

At block 520, the example TX MAC 318 transmits the mirrored packet to the CPU 300 (e.g., the latency correction circuitry 216 of the host application 104 implemented by the CPU 300). At block 522, the latency correction circuitry 216 generates a correction factor based on the first and second timestamps. For example, the latency correction circuitry 216, after obtaining the mirrored packet, determines the first timestamp from header of the mirrored packet and determines the second timestamp by accessing the TS7 timestamp for the corresponding maintenance packet from a buffer via a control-plane API. The latency correction circuitry 216 may generate a correction factor based on a mathematical difference between the second timestamp and the first timestamp (e.g., TS7-TS5).

At block 524, the example latency correction circuitry 216 stores the correction factor into the correction factor storage 218 (e.g., based on the timestamp profile identifier). In some examples, the latency correction circuitry 216 calculates an average correction factor based on the generated correction factor for the maintenance data packet and one or more previous correction factors generated from previous maintenance packet(s) that correspond to the same timestamp profile identifier. In such examples, the latency correction circuitry 216 stores the average correction factor for the timestamp profile identifier in the correction factor storage 218. As further described below in conjunction with FIG. 6, the TS calculation circuitry 220 uses the correction factors to adjust a semi accurate timestamp into an accurate timestamp to generate an egress timestamp and transmits the egress timestamp to the host application 104. In this manner, the host application 104 can quickly generate a second maintenance packet with the egress timestamp for time synchronization and/or QoS measurement purposes.

FIG. 6 is a flowchart representative of example machine readable instructions and/or example operations 600 that may be executed, instantiated, and/or performed by programmable circuitry(ies) to generate to generate egress timestamps based on a semi accurate timestamp and a correction factor corresponding to historical timestamp data. For example, the example operations 600 may be executed, instantiated, and/or performed by the latency correction circuitry 216 of FIGS. 2 and/or 3. The example machine-readable instructions and/or the example operations 600 of FIG. 6 begin at block 601, at which the TS calculation circuitry 220 determines if a data packet copy and/or mirrored data packet has been received. As described above, when the host application 104 transmits instructions to output a data packet and/or maintenance packet and generate a corresponding egress timestamp, the network circuitry 106 will transmit a copy of the data packet (or information corresponding to the data packet) and/or a mirrored data packet to the TS calculation circuitry 220. The data packet copy and/or mirrored data packet will include a semi-accurate timestamp generated and/or captured by the TS calculation circuitry 220.

If the TS calculation circuitry 220 determines that a data packet copy and/or mirrored data packet has not been obtained (block 601: NO), control returns to block 601 until a data packet is obtained by the TS calculation circuitry 220. If the TS calculation circuitry 220 determines that a data packet copy and/or mirrored data packet has been obtained (block 601: YES), the TS calculation circuitry 220 determines the TS profile identifier (or other data packet characteristic) associated with the data packet copy and/or mirrored data packet (block 602). As described above, the TS calculation circuitry 220 can determine the TS profile identifier based on the metadata of the data packet copy or mirrored data packet. At block 604, the example TS calculation circuitry 220 accesses a correction factor associated with the TS profile identifier from the correction factor storage 218. As described above, the correction factor corresponds to one or more calculation factors generated based on one or more previous data packets and/or maintenance packets.

At block 606, the example TS calculation circuitry 220 applies the accessed calculation factor to a semi-accurate timestamp to generate an accurate egress timestamp for the data packet associated with the data packet copy and/or mirrored data packet. As described above, when the host application 104 transmits the data packet to the networking circuitry 106, the networking circuitry 106 generates a semi-accurate timestamp and returns the semi-accurate timestamp to the TS calculation circuitry 220 with the data packet copy and/or mirrored data packet. The correction factor corresponds to an approximate amount of time needed for the data packet to be output by the ethernet port 320 after the semi-accurate timestamp is captured. Accordingly, the TS calculation circuitry 220 generates an accurate egress timestamp by applying (e.g., adding) the correction factor to the semi-accurate timestamp.

In some examples, the TS calculation circuitry 220 can determine if application of the correction factor is needed and/or desired. For example, semi-accurate timestamps may be sufficient for some data packets and/or applications. In such an example, the TS calculation circuitry 220 can determine if the semi-accurate timestamp is sufficient and transmit the egress timestamp to the host application 104 based on the semi-accurate timestamp without applying the correction factor.

At block 608, the TS calculation circuitry 220 transmits the accurate egress timestamp for the data packet to the host application 104. In this manner, the host application 104 can generate a second, follow-up data packet including the accurate egress timestamp to the node 108 (e.g., via the networking circuity 106) for time synchronization and/or QoS measurement purposes.

FIG. 7 is a block diagram of an example programmable circuitry platform 700 structured to execute and/or instantiate the example machine-readable instructions and/or the example operations of FIGS. 4-6 to implement the processor circuitry 702 and/or RIC circuitry 710 of FIG. 8 and/or 9. The programmable circuitry platform 700 can be, for example, a server, a personal computer, a workstation, a self-learning machine (e.g., a neural network), or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, DSPs, and/or microcontrollers from any desired family or manufacturer. The programmable circuitry 712 may be implemented by one or more semiconductor based (e.g., silicon based) devices. In this example, the host application 104, the network stack 202, the network drive 204, the S/W egress pipeline 206, the NIC 208, the TS capture circuitry 210, the ethernet port logic circuitry 212, the ethernet ports 214, the latency correction circuitry 216, the correction factor storage 218, the TS calculation circuitry 220, the CPU 300, the input buffer 304, the ingress pipeline 306, the queuing circuitry 310, the egress pipeline 312, the TX MAC 318, the ethernet ports 320 of FIGS. 2 and/or 3.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, a keyboard, a button, a mouse, and/or a touchscreen.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, an optical fiber connection, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 732, which may be implemented by the machine readable instructions of FIGS. 4-6, may be stored in the mass storage device 728, in the volatile memory 714, in the non-volatile memory 716, and/or on at least one non-transitory computer readable storage medium such as a CD or DVD which may be removable.

FIG. 8 is a block diagram of an example implementation of the programmable circuitry 712 of FIG. 7. In this example, the programmable circuitry 712 of FIG. 7 is implemented by a microprocessor 800. For example, the microprocessor 800 may be a general-purpose microprocessor (e.g., general-purpose microprocessor circuitry). The microprocessor 800 executes some or all of the machine-readable instructions of the flowcharts of FIGS. 4-6 to effectively instantiate the circuitry of FIG. 2 as logic circuits to perform operations corresponding to those machine readable instructions. In some such examples, the circuitry of FIGS. 8 and/or 9 is instantiated by the hardware circuits of the microprocessor 800 in combination with the machine-readable instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowcharts of FIGS. 4-6.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus, a Serial Peripheral Interface (SPI) bus, a PCI bus, or a PCIe bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating-point operations. In yet other examples, the AL circuitry 816 may include first AL circuitry that performs integer-based operations and second AL circuitry that performs floating-point operations. In some examples, the AL circuitry 816 may be referred to as an Arithmetic Logic Unit (ALU).

The registers 818 are semiconductor-based structures to store data and/or instructions such as results of one or more of the operations performed by the AL circuitry 816 of the corresponding core 802. For example, the registers 818 may include vector register(s), SIMD register(s), general-purpose register(s), flag register(s), segment register(s), machine-specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure, such as by being distributed throughout the core 802 to shorten access time. The second bus 822 may be implemented by at least one of an I2C bus, a SPI bus, a PCI bus, or a PCIe bus.

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages.

The microprocessor 800 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 800, in the same chip package as the microprocessor 800 and/or in one or more separate packages from the microprocessor 800.

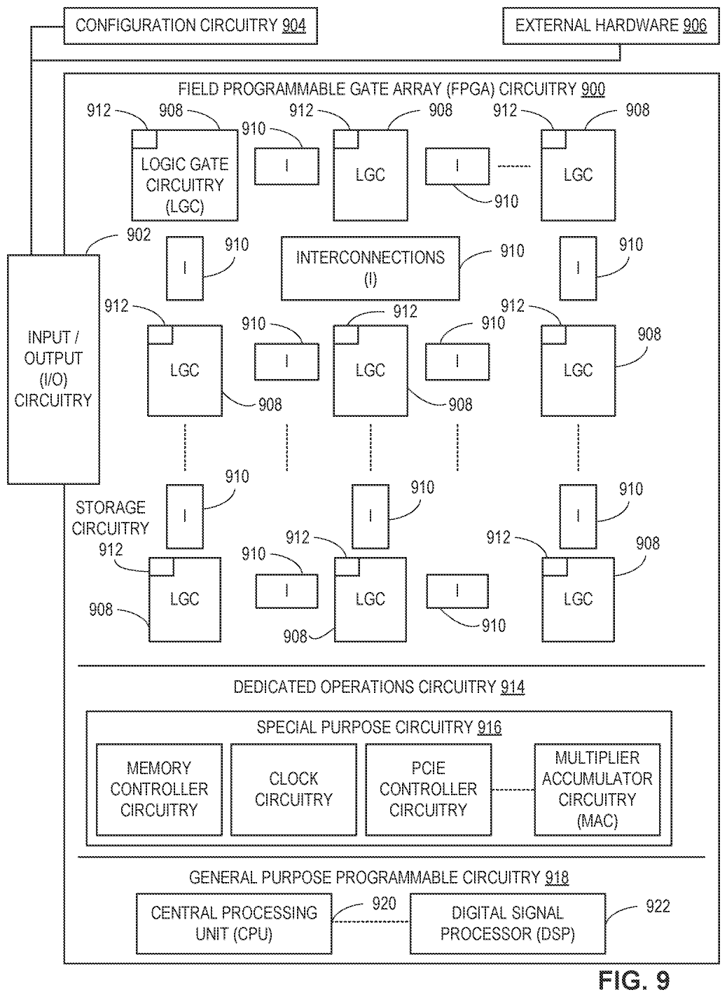

FIG. 9 is a block diagram of another example implementation of the programmable circuitry 712 of FIG. 7. In this example, the programmable circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 800 of FIG. 8 described above (which is a general purpose device that may be programmed to execute some or all of the machine readable instructions represented by the flowchart(s) of FIGS. 4-6 but whose interconnections and logic circuitry are fixed once fabricated), the FPGA circuitry 900 of the example of FIG. 9 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 4-6. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 4-6. As such, the FPGA circuitry 900 may be configured and/or structured to effectively instantiate some or all of the operations/functions corresponding to the machine readable instructions of the flowchart(s) of FIGS. 4-6 as dedicated logic circuits to perform the operations/functions corresponding to those software instructions in a dedicated manner analogous to an ASIC. Therefore, the FPGA circuitry 900 may perform the operations/functions corresponding to the some or all of the machine readable instructions of FIGS. 4-6 faster than the general-purpose microprocessor can execute the same.

In the example of FIG. 9, the FPGA circuitry 900 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain a binary file, which may be implemented by a bit stream, data, and/or machine-readable instructions, to configure the FPGA circuitry 900, or portion(s) thereof. In some such examples, the configuration circuitry 904 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 906 may be implemented by external hardware circuitry. For example, the external hardware 906 may be implemented by the microprocessor 800 of FIG. 8.

The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations/functions that may correspond to at least some of the machine readable instructions of FIGS. 4-6 and/or other desired operations. The logic gate circuitry 908 shown in FIG. 9 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations/functions. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example dedicated operations circuitry 914. In this example, the dedicated operations circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the programmable circuitry 712 of FIG. 7, many other approaches are contemplated. For example, FPGA circuitry may include an on-board CPU, such as one or more of the example CPU 920 of FIG. 8. Therefore, the programmable circuitry 712 of FIG. 7 may additionally be implemented by combining at least the example microprocessor 800 of FIG. 8 and the example FPGA circuitry 900 of FIG. 9. In some such hybrid examples, one or more cores 802 of FIG. 8 may execute a first portion of the machine readable instructions represented by the flowchart(s) of FIGS. 4-6 to perform first operation(s)/function(s), the FPGA circuitry 900 of FIG. 9 may be configured and/or structured to perform second operation(s)/function(s) corresponding to a second portion of the machine readable instructions represented by the flowcharts of FIGS. 4-6, and/or an ASIC may be configured and/or structured to perform third operation(s)/function(s) corresponding to a third portion of the machine readable instructions represented by the flowcharts of FIGS. 4-6.

It should be understood that some or all of the circuitry of FIGS. 8 and/or 9 may, thus, be instantiated at the same or different times. For example, same and/or different portion(s) of the microprocessor 800 of FIG. 8 may be programmed to execute portion(s) of machine-readable instructions at the same and/or different times. In some examples, same and/or different portion(s) of the FPGA circuitry 900 of FIG. 9 may be configured and/or structured to perform operations/functions corresponding to portion(s) of machine-readable instructions at the same and/or different times.

In some examples, some or all of the circuitry of FIGS. S and/or 9 may be instantiated, for example, in one or more threads executing concurrently and/or in series. For example, the microprocessor 800 of FIG. 8 may execute machine readable instructions in one or more threads executing concurrently and/or in series. In some examples, the FPGA circuitry 900 of FIG. 9 may be configured and/or structured to carry out operations/functions concurrently and/or in series. Moreover, in some examples, some or all of the processor circuitry 702 and/or the RIC circuitry 710 of FIGS. 8 and/or 9 may be implemented within one or more virtual machines and/or containers executing on the microprocessor 800 of FIG. 8.

In some examples, the programmable circuitry 712 of FIG. 7 may be in one or more packages. For example, the microprocessor 800 of FIG. 8 and/or the FPGA circuitry 900 of FIG. 9 may be in one or more packages. In some examples, an XPU may be implemented by the programmable circuitry 712 of FIGS. 7, which may be in one or more packages. For example, the XPU may include a CPU (e.g., the microprocessor 800 of FIG. 8, the CPU 920 of FIG. 9, etc.) in one package, a DSP (e.g., the DSP 922 of FIG. 9) in another package, a GPU in yet another package, and an FPGA (e.g., the FPGA circuitry 900 of FIG. 9) in still yet another package.

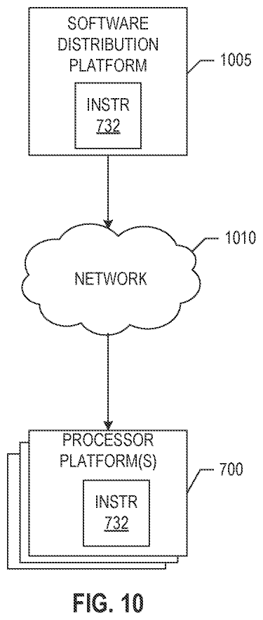

A block diagram illustrating an example software distribution platform 1005 to distribute software such as the example machine readable instructions 732 of FIG. 7 to other hardware devices (e.g., hardware devices owned and/or operated by third parties from the owner and/or operator of the software distribution platform) is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine readable instructions 732 which may correspond to the example machine readable instructions of FIGS. 4-6, as described above. The one or more servers of the example software distribution platform 1005 are in communication with an example network 1010, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 732 from the software distribution platform 1005. For example, the software, which may correspond to the example machine readable instructions of FIGS. 4-6, may be downloaded to the example programmable circuitry platform 700 which is to execute the machine readable instructions 732 to implement the processor circuitry 702 and/or the RIC circuitry 710. In some examples, one or more servers of the software distribution platform 1005 periodically offer, transmit, and/or force updates to the software (e.g., the example machine readable instructions 732 of FIG. 7) to ensure improvements, patches, updates, etc., are distributed and applied to the software at the end user devices. Although referred to as software above, the distributed “software” could alternatively be firmware.

Example methods, apparatus, systems, and articles of manufacture to generate a timestamp are disclosed herein. Further examples and combinations thereof include the following :Example 1 includes a non-transitory machine readable storage medium comprising instructions to cause programmable circuitry to at least generate a correction factor based on a first timestamp and a second timestamp, the first timestamp associated with a first data packet being obtained by an ethernet physical coding sublayer (PCS), the second timestamp generated before the first data packet is obtained by a physical ethernet port coupled to the ethernet PCS, and generate a third timestamp for a second data packet based on the correction factor and a fourth timestamp, the fourth timestamp generated by network interface circuitry for the second data packet.

Example 2 includes the non-transitory machine readable storage medium of example 1, wherein the instructions cause the programmable circuitry to generate the correction factor based on a difference between the second timestamp and the first timestamp.

Example 3 includes the non-transitory machine readable storage medium of example 1, wherein the instructions cause the programmable circuitry to generate the correction factor based on an average correction factor, the average correction factor based on (a) a first correction factor corresponding to the first timestamp and the second timestamp and (b) a second correction factor corresponding to a fifth timestamp of a third data packet and a sixth timestamp of the third data packet.

Example 4 includes the non-transitory machine readable storage medium of example 1, wherein the instructions cause the programmable circuitry to store the correction factor based on a characteristic of the first data packet.

Example 5 includes the non-transitory machine readable storage medium of example 1, wherein the third timestamp is more accurate than the fourth timestamp.

Example 6 includes the non-transitory machine readable storage medium of example 1, wherein the instructions cause the programmable circuitry to add the correction factor to the fourth timestamp to generate the third timestamp for the second data packet.

Example 7 includes the non-transitory machine readable storage medium of example 1, wherein the instructions cause the programmable circuitry to determine that the second data packet corresponds to a same identifier as the first data packet, and select the correction factor for generating the third timestamp based on the second data packet corresponding to the same identifier as the first data packet.

Example 8 includes the non-transitory machine readable storage medium of example 1, wherein the first timestamp is generated before the first data packet is obtained by the ethernet PCS.

Example 9 includes a non-transitory machine readable storage medium comprising instructions to cause programmable circuitry to at least access a correction factor corresponding to an identifier of a data packet, and generate an egress timestamp for the data packet based on a timestamp captured associated with transmission of the data packet and the correction factor.

Example 10 includes the non-transitory machine readable storage medium of example 9, wherein the instructions cause the programmable circuitry to determine the identifier of the data packet, the identifier corresponding to a characteristic of the data packet.

Example 11 includes the non-transitory machine readable storage medium of example 9, wherein the instructions cause the programmable circuitry to cause transmission of the egress timestamp to a host application for at least one of time synchronization or a quality of service measurement.

Example 12 includes the non-transitory machine readable storage medium of example 9, wherein the correction factor is based on historical timestamp information.

Example 13 includes the non-transitory machine readable storage medium of example 9, wherein the instructions cause the programmable circuitry to determine whether to apply the correction factor to generate the egress timestamp.

Example 14 includes an apparatus comprising memory, computer readable instructions, and programmable circuitry to instantiate latency correction circuitry to generate a correction factor based on a first timestamp and a second timestamp, the first timestamp associated with a first data packet being obtained by an ethernet physical coding sublayer (PCS), the second timestamp generated before the first data packet is obtained by a physical ethernet port coupled to the ethernet PCS, and timestamp calculation circuitry to generate a third timestamp for a second data packet based on the correction factor and a fourth timestamp, the fourth timestamp generated by network interface circuitry for the second data packet.

Example 15 includes the apparatus of example 14, wherein the latency correction circuitry is to generate the correction factor based on a difference between the second timestamp and the first timestamp.

Example 16 includes the apparatus of example 14, wherein the latency correction circuitry is to generate the correction factor based on an average correction factor, the average correction factor based on (a) a first correction factor corresponding to the first timestamp and the second timestamp and (b) a second correction factor corresponding to a fifth timestamp of a third data packet and a sixth timestamp of the third data packet.

Example 17 includes the apparatus of example 14, wherein the latency correction circuitry is to store the correction factor based on a characteristic of the first data packet.

Example 18 includes the apparatus of example 14, wherein the third timestamp is more accurate than the fourth timestamp.

Example 19 includes the apparatus of example 14, wherein the timestamp calculation circuitry is to add the correction factor to the fourth timestamp to generate the third timestamp for the second data packet.

Example 20 includes the apparatus of example 14, wherein the timestamp calculation circuitry is to determine that the second data packet corresponds to a same identifier as the first data packet, and select the correction factor for generating the third timestamp based on the second data packet corresponding to the same identifier as the first data packet.

From the foregoing, it will be appreciated that example systems, apparatus, articles of manufacture, and methods have been disclosed that generate accurate egress timestamps. Disclosed systems, apparatus, articles of manufacture, and methods improve the speed at which an accurate egress timestamp can be generated without adding complexity and/or data packet storage to network circuitry. Disclosed systems, apparatus, articles of manufacture, and methods are accordingly directed to one or more improvement(s) in the operation of a machine such as a computer or other electronic and/or mechanical device.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A non-transitory machine readable storage medium comprising instructions to cause programmable circuitry to at least:
generate a correction factor based on a first timestamp and a second timestamp, the first timestamp associated with a first data packet being obtained by an ethernet physical coding sublayer (PCS), the second timestamp generated before the first data packet is obtained by a physical ethernet port coupled to the ethernet PCS; and
generate a third timestamp for a second data packet based on the correction factor and a fourth timestamp, the fourth timestamp generated by network interface circuitry for the second data packet.

2. The non-transitory machine readable storage medium of claim 1, wherein the instructions cause the programmable circuitry to generate the correction factor based on a difference between the second timestamp and the first timestamp.

3. The non-transitory machine readable storage medium of claim 1, wherein the instructions cause the programmable circuitry to generate the correction factor based on an average correction factor, the average correction factor based on (a) a first correction factor corresponding to the first timestamp and the second timestamp and (b) a second correction factor corresponding to a fifth timestamp of a third data packet and a sixth timestamp of the third data packet.

4. The non-transitory machine readable storage medium of claim 1, wherein the instructions cause the programmable circuitry to store the correction factor based on a characteristic of the first data packet.

5. The non-transitory machine readable storage medium of claim 1, wherein the third timestamp is more accurate than the fourth timestamp.

6. The non-transitory machine readable storage medium of claim 1, wherein the instructions cause the programmable circuitry to add the correction factor to the fourth timestamp to generate the third timestamp for the second data packet.

7. The non-transitory machine readable storage medium of claim 1, wherein the instructions cause the programmable circuitry to:
determine that the second data packet corresponds to a same identifier as the first data packet; and
select the correction factor for generating the third timestamp based on the second data packet corresponding to the same identifier as the first data packet.

8. The non-transitory machine readable storage medium of claim 1, wherein the first timestamp is generated before the first data packet is obtained by the ethernet PCS.

9. A non-transitory machine readable storage medium comprising instructions to cause programmable circuitry to at least:
access a correction factor corresponding to an identifier of a data packet; and
generate an egress timestamp for the data packet based on a timestamp captured associated with transmission of the data packet and the correction factor.

10. The non-transitory machine readable storage medium of claim 9, wherein the instructions cause the programmable circuitry to determine the identifier of the data packet, the identifier corresponding to a characteristic of the data packet.

11. The non-transitory machine readable storage medium of claim 9, wherein the instructions cause the programmable circuitry to cause transmission of the egress timestamp to a host application for at least one of time synchronization or a quality of service measurement.

12. The non-transitory machine readable storage medium of claim 9, wherein the correction factor is based on historical timestamp information.

13. The non-transitory machine readable storage medium of claim 9, wherein the instructions cause the programmable circuitry to determine whether to apply the correction factor to generate the egress timestamp.

14. An apparatus comprising:
memory;
computer readable instructions; and
programmable circuitry to instantiate:
latency correction circuitry to generate a correction factor based on a first timestamp and a second timestamp, the first timestamp associated with a first data packet being obtained by an ethernet physical coding sublayer (PCS), the second timestamp generated before the first data packet is obtained by a physical ethernet port coupled to the ethernet PCS; and
timestamp calculation circuitry to generate a third timestamp for a second data packet based on the correction factor and a fourth timestamp, the fourth timestamp generated by network interface circuitry for the second data packet.

15. The apparatus of claim 14, wherein the latency correction circuitry is to generate the correction factor based on a difference between the second timestamp and the first timestamp.

16. The apparatus of claim 14, wherein the latency correction circuitry is to generate the correction factor based on an average correction factor, the average correction factor based on (a) a first correction factor corresponding to the first timestamp and the second timestamp and (b) a second correction factor corresponding to a fifth timestamp of a third data packet and a sixth timestamp of the third data packet.

17. The apparatus of claim 14, wherein the latency correction circuitry is to store the correction factor based on a characteristic of the first data packet.

18. The apparatus of claim 14, wherein the third timestamp is more accurate than the fourth timestamp.

19. The apparatus of claim 14, wherein the timestamp calculation circuitry is to add the correction factor to the fourth timestamp to generate the third timestamp for the second data packet.

20. The apparatus of claim 14, wherein the timestamp calculation circuitry is to:
determine that the second data packet corresponds to a same identifier as the first data packet; and
select the correction factor for generating the third timestamp based on the second data packet corresponding to the same identifier as the first data packet.
